(19) United States
(12) Patent Application Publication
(10) Pub. No.: US 2001/0052933 A1
(43) Pub. Date: Dec. 20, 2001

(54) System and method for image capture, storage and retrieval

(76) Inventors: Larry Carl Nybo, Layton, UT (US); Craig Lee Nybo, Kaysville, UT (US); John Scott Brummet, Ogden, UT (US); Scott Gilbert Adamson, Bountiful, UT (US); James Quentin Bates, Salt Lake City, UT (US); George Edd Richards, Jr., Bountiful, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/753,935

(22) Filed: Jan. 3, 2001

Related U.S. Application Data
(60) Provisional application No. 60/175,770, filed on Jan. 12, 2000.

(51) Int. Cl. H04N 9/04; H04N 5/225

(52) U.S. Cl. 348/207; 348/231; 348/220

(57) ABSTRACT

A system and method for image capture, storage, and retrieval, which captures one or more images in a digital format and stores the images in a database to improve their accessability. The system and method also stores the images in a smaller physical space than conventional systems and may be used with a variety of image capture devices. Furthermore, the system and method may also allow access to the images from remote locations by way of a computer network such as the Internet.

### BACKGROUND OF THE INVENTION

### RELATED APPLICATIONS

The present application claims priority to U.S. Provisional Application No. 60/175,770, entitled “Image Capturing String and Retrieval Apparatus and Method,” filed Jan. 12, 2000, which is hereby incorporated by reference.

### THE FIELD OF THE INVENTION

The present invention relates to the use of computers in managing large quantities of images commonly managed and stored on film. More specifically, the invention relates to a system which uses a database to facilitate capture, storage and retrieval of images in digital format.

### TECHNICAL BACKGROUND

They say a picture is worth a thousand words. This being the case, a video clip speaks volumes. Pictorial representations of real world images provide an abundance of information in a simple, easy to understand format. Because of the power of pictures to convey information, they are used in numerous industries including security, dentistry, medicine, movie making, law, and various other industries to varying degrees. These images, referring to both single pictures as well as videos, may serve their purpose in a short time period or may continue to be useful for many years after being created.

Images with a short useful life can be very costly to produce. The cost of materials, camera, film, and developing, can quickly add up. A good example of images with a short useful life are security surveillance images. If a camera is filming a street corner 24 hours a day, and 7 days a week, and no crimes are reported at that corner for a year, then the images can be discarded with a reasonable probability that they will no longer be needed. The expended film or videotapes and facilities to store and catalog the images for the year can be very expensive.

The costs of materials, storage, and management only increase in industries where the images have a longer useful life. For example, in the medical industry images are created using a number of image capture devices (referred to hereinafter simply as cameras). Some of these are special imaging machines, others are simple video cameras. Examples of imaging devices include computerized axial tomography (CAT scans), X-rays, magnetic resonance imaging (MRIs), ultrasounds, and videos. These imaging devices create images of parts of the patient's body both externally and internally. The imaging devices are invaluable tools used by a medical practitioner in diagnosis and treatment of patients.

In an industry such as medicine, the usefulness of images may be for at least the lifetime of a particular patient and even longer depending on the disease involved and the purpose for which the image was made. This means each image creates a separate piece of developed film, or video tape which must be stored and maintained in the event a medical practitioner or patient needs to review it in the future. Generally, these images are stored in filing rooms with other records concerning the patient. Alternatively, the images are stored all together in separate rooms dedicated to the storage of images. The physical sizes of the images and tapes require that large rooms be made available to store the images. In addition, some sort of filing system must be maintained so that the images can be retrieved in the future. Furthermore, a medical practitioner may seek to have a colleague or expert in a different geographic location review and provide an opinion regarding a particular image. Generally, this is accomplished by mailing the film or video to the colleague, or bringing the colleague to the facility where the image is stored.

The physical difficulties involved in using images recorded on conventional film, or video tape increase the costs. An industry, such as the medical industry, has to pay a great deal to capture, manage and maintain images. In addition, conventional images are very difficult to organize and archive effectively. While microfiche is often used to reduce the image sizes, this does not solve the physical management and retrieval problems which exist.

Accordingly, it would be an advancement in the art to provide a system and method for image capture, storage, and retrieval which captures one or more images in a digital format. A further advancement in the art would be to provide a system and method for image capture, storage, and retrieval which stores digital images in a database. It would be another advancement in the art to provide a system and method for image capture, storage, and retrieval which provides for the retrieval of digital images in a quick and efficient manner. A further advancement in the art would be to provide a system and method for image capture, storage, and retrieval which reduces the physical size of the images such that more images may be stored in a smaller space. It would be a further advancement in the art to provide a system and method for image capture, storage, and retrieval which is flexible enough to be used with a variety of image capture devices. It would be another advancement in the art to provide a system and method for image capture, storage, and retrieval which allows the images to be used and managed from a location which is remote from where the image was captured. The present invention provides these advancements in a novel and useful way.

### BRIEF SUMMARY OF THE INVENTION

The system and method of the present invention has been developed in response to the present state of the art, and in particular, in response to the problems and needs in the art that have not yet been fully solved by currently available image capture, storage and retrieval systems. Thus, the present invention provides a system and method for capturing images in a digital format, storing them in a database, and retrieving the images later from a local or remote location.

In one embodiment, the invention is a system including an input module. The input module receives image data from an image data generation device. An image data generation device may be a special purpose video camera, general purpose video camera or any machine such as an X-ray or MRI which also creates image data. The input module includes a buffer for holding a desired quantity of image data within the input module for capture by the input module. Image data which is not captured is simply discarded.

The system also includes a trigger. The trigger may be a physical component attached to the system or a logical component implemented in software within the system. A trigger allows a user to indicate to the system when an image is to be captured. The trigger may operate automatically or solely by manual initiation by the user. The trigger creates a trigger event. A trigger event is a signal that the user desires the system to capture an image. Frequently, the trigger event is used in relation to a particular point in time to capture an image.

The system includes a processing module connected to a database, and a user interface. The processing module waits for the trigger event before capturing images. The trigger event signals the processing module to begin the process of capturing an image. The trigger event may signal the capture of a single digital image or of multiple digital images to form a video clip. The processing module is configured to distinguish between signaling of single or multiple digital images.

The processing module creates a data structure for organizing the digital image or video clip. Next, the processing module stores the digital image or video clip in the data structure. The processing module also stores pre-defined image identification data in the same data structure. Pre-defined image identification data is data which a user has specified prior to activating the trigger. The image identification data is data the user desires to associate with the image or video clip to aide in retrieval and use of the digital image or video clip. Image identification data may include, individually or in combination, data such as a time stamp, date stamp, patient's name, patient's identification number, and the like.

Next, the processing module stores the data structure in the database. Utilizing a database allows for efficient management of the data structures holding the digital image or video clip. The database can be enlarged or shrunk simply by adding more storage devices, i.e. hard drives, to the database. Upon storing the data structure the processing module may also index the data structure in the database based on the image identification data provided. Indexing allows for faster retrieval of data structures stored in the database.

Finally, the processing module makes the digital image or video clip available to a user interface. The user interface may be a combination of hardware and software which enables a user to use and administer the data structures in the database. In one embodiment, the user interface may include a computer network connection and the input and output devices of the user interface may be in a location which is geographically remote in relation to the database and/or the system. Because the image data is now in a digital format the uses available to the user through the user interface are numerous. For example, a user may print or view a digital image, play back or broadcast a video clip, or store the digital image on a remote or portable storage medium.

In one embodiment, the present invention may include functionality within the processing module such that data structures are stored in local storage if the database is unavailable. In addition, this embodiment may also provide that once the database becomes available, the system moves data structures stored in local storage to the database.

In another aspect, the system includes an archive system. The archive system includes a catalog, archive medium, and an archive. The archive system allows a user to transfer data structures from the database to an archive medium. The user notes on the archive medium, and in the catalog, a label for the data structure or sets of data structures. This label identifies where in the archive the archive medium is stored and a description of the one or more data structures stored on the archive medium.

These and other features, and advantages of the present invention will become more fully apparent from the following description and appended claims, or may be learned by the practice of the invention as set forth hereinafter.

### BRIEF DESCRIPTION OF THE DRAWINGS

The foregoing and other features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a block diagram of one embodiment of the system of the present invention illustrating modules, components, and the data flow between them;

FIG. 2 is a block diagram illustrating the relationships in an embodiment of the system which implements local storage functionality and remote database and user interface access;

FIG. 3 is a block diagram illustrating an archive system, the archive medium, and a catalog maintained by the system;

FIG. 4 is a block diagram illustrating a computer system suitable for implementing one embodiment of the invention; and

FIG. 5 is a flow-chart illustrating the steps of a method in one embodiment of the invention.

The figures depict embodiments of the present invention for purposes of illustration only. One skilled in the art will readily recognize from the following discussion that alternative embodiments of the illustrated structures and methods may be employed without departing from the principles of the invention described herein.

### DETAILED DESCRIPTION OF THE PREFERRED EMBODIMENTS

The present invention can be better understood with reference to the drawings where like parts are designated with like numerals throughout. The present invention leverages the power and efficiency available through a database and data in a digital format. It will be appreciated by those of skill in the art, that the components of the present invention may be implemented in hardware, firmware, software or any combination of the these.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

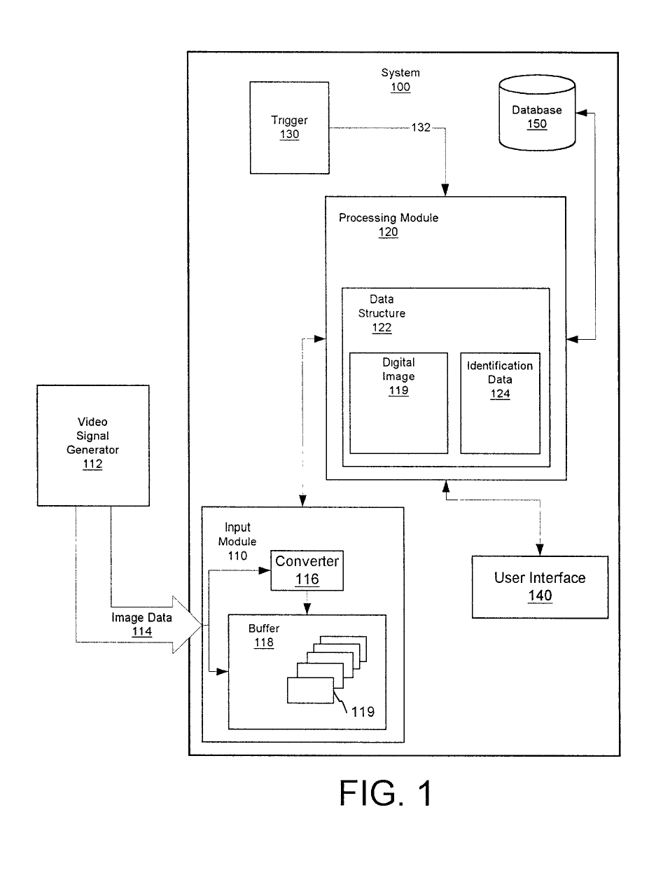

FIGS. 1 through 5 are schematic block diagrams and a flow chart diagram which illustrate in more detail certain embodiments of hardware and software modules for operation in accordance with certain embodiments of the present invention.

Referring now to FIG. 1, an image capture, storage, and retrieval system 100 is presented. The system 100 includes an input module 110, a processing module 120, a trigger 130, a user interface 140, and a database 150. These components cooperate to provide the necessary functionality.

The input module 110 serves to provide digital image data from a video signal generator 112 to the system 100. The input module 110 is configured to receive image data 114 in one of two formats, digital and analog. The input module 110 may be further configured to accept image data 114 in a variety of protocols used to transmit in those formats. If the image data 114 entering the input module 110 is in analog format, the input module 110 may include a converter 116. The converter 116 receives the analog image data 114 and converts it into digital format. Once, the converter 116 produces digital image data 114 the digital image data 114 is stored in a storage buffer 118. Alternatively, the video signal generator 112 may provide the image data 114 in a digital format which by-passes the converter 116 and enters the buffer 118 directly.

The buffer 118 is a module which temporarily stores a desired quantity of image data. The buffer 118 may be implemented in software or hardware. A buffer 118 may have a pre-set storage capacity. Alternatively, the storage capacity may be varied by a user operating the system 100. Generally, the storage capacity of the buffer may be between 64 KB and 1 MB.

Digital image data 114 in the buffer 118 changes continually. As new image data 114 enters the buffer 118, old image data 114 is over written and discarded. Generally, image data 114 is stored in the buffer 118 in quantities which together create a single digital image 119. A digital image 119 is a quantity of image data 114 in digital format which re-creates the actual image at a single point in time. Video signal generators 112 may create one or more digital images 119.

A video signal generator 112 may be a video camera, an ultrasound machine, an MRI machine, an X-ray machine, and other like video signal generators 112. The digital images 119 may be created using the analog video camera and a converter 116. Alternatively, the digital images 119 may be created by a digital video camera. As a further alternative, the digital images 119 may be generated by other imaging, scanning, or digital image creation techniques. For example, an MRI creates a digital image 119 from computer calculations involving magnetic fields reacting to radio frequency waves passing through an object. The quantity of image data 114 required to create a single digital image 119 varies. Factors such as the quality of the camera or imaging device, whether the image is to be captured in color or black and white, and the format of the digital image data 114 may greatly effect the amount of image data 114 needed to create a digital image 119.

A video signal generator 112 may be a simple video camera with the video out signal connected to the input module 110 of the system 100. Alternatively, the video signal generator 112 may be a highly specialized video camera such as a medical video camera. Medical video cameras are configured to provide video images of various parts of a patient's body. For example, an arthroscope is a very small camera which is inserted into the knee to give a practitioner a view inside without entirely opening the skin covering the knee. Additionally, medical video cameras exist for capturing video of macro and micro views of surgery and other medical procedures. For example, a medical video camera may include a general purpose video camera focused on a patient during surgery. Alternatively, the medical video camera may be a camera filming the microscopic view of organisms under a microscope.

Single digital images 119 and/or video clips can provide valuable training and diagnostic tools to practitioners in fields implementing the invention. Doctors may use the images 119 to train students. Security personnel may use the invention to identify suspects in a crime recorded by the system 100. There are a variety of fields which use one form of video signal generator 112 or another. Each of these fields may benefit from the present invention.

As a digital image 119 is stored in the buffer 118, a previously stored digital image 119 is over written and thereby lost. Digital images 119 stored in the buffer 118 may be stored according to the last in, first out (‘LIFO’) data structure protocol. Under this protocol, the last data element stored in the structure is the first to come out, or be used. Generally, the user of the system 100 will want to capture the last digital image 119 or set of digital images 119 which they have filmed. Using a LIFO protocol for storage allows the user to easily capture the most recent digital images 119 which the video signal generator 112 created. Alternatively, another protocol such as first in, first out (‘FIFO’) or the like may be used.

Referring still to FIG. 1, the processing module 120 cooperates with the input module 110 and the trigger 130 to capture one or more digital images 119 from the buffer 118. Multiple successive digital images 119 may be captured to create a video clip. Interaction between the input module 110 and the processing module 120 is controlled by the trigger 130. The video signal generator 112 is constantly adding and deleting digital images 119 in the buffer 118 under the LIFO protocol. The trigger 130 identifies the one or more digital images 119 which the system 100 is to capture.

A trigger 130 may be activated manually or automatically according to some criteria such as the passing of time. A trigger 130 may take various forms including a joystick button, a switch, a key press, a mouse click on a software button, and the like. Alternatively, the trigger 130 may be a motion detector, a passage of a specific period of time, a light sensor, sound detector, voice activated, and other like event or user initiated action. The purpose of the trigger 130 is to signal to the system 100 when a digital image 119 is to be captured, how many to capture, and how the one or more images 119 are to be identified once stored in the database 150.

All of the information which a trigger 130 is responsible for is communicated to the processing module 120 by way of a trigger event 132. A trigger event 132 is an electronic signal to the processing module 120 that the user has requested the capture of one or more digital images 119. Generally, information on how many digital images 119, and how the one or more digital images 119 are to be identified is defined by the user prior to the initiation of the trigger 130. Prior to using the trigger 130, the user may set a number of variables within the memory of the system 100. One of these variables may be an indicator of whether a trigger event 132 causes the capture of a single or multiple digital images 119 and/or digital video.

Alternatively, a first trigger 130 may exist to signal capture of a single digital image 119 and a second trigger 130 may exist for signal capture of multiple digital images 119 and/or video. As a further alternative, the trigger 130 may be configured such that use according to a particular protocol indicates whether the system 100 captures a single or multiple digital images 119. For example, holding the button down for one second may indicate a trigger event 132 for capturing multiple digital images 119. Whereas, holding the button of the trigger 130 for less than one second may signal the system 100 to capture a single digital image 119.

Once a trigger event 132 is received by the processing module 120, the processing module 120 responds. The processing module 120 creates a data structure 122. The data structure 122 is configured to store one or more digital images 119 and their accompanying identification data 124. Examples of data structure 122 include an array, a database record, a linked list, a queue, a stack, and the like.

Next, the processing module 120 stores a copy of the one or more requested digital images 119 in the data structure 122. The images 119 may be stored in the same format as in the buffer 118. Alternatively, a single image 119 may be stored in the data structure 122 according to a joint photographic experts group (JPEG) algorithm. The JPEG algorithm is a protocol for the compression of digital images 119. The JPEG algorithm allows a high quality digital image 119 to use less space for storage. In a further alternative, a series of digital images 119, such as a video clip, may be stored in the data structure 122 according to a motion picture experts group (MPEG) algorithm. The MPEG algorithm allows video clips to be compressed such that they require less storage space while maintaining high quality.

The processing module 120 also stores identification data 124 in the data structure 122 which correlates to the digital image 119. The identification data 124 serves to uniquely describe the digital image 119. Generally, identification data 124 is defined by the user prior to the initiation of the trigger 130.

Identification data 124 may include a digital image name, description, time stamp, date stamp, an identification number, and other like identifying data elements. These data elements may be used alone or in combination to uniquely identify the digital image 119 from all others captured. Alternatively, the data elements may be the same as previously captured digital images 119 with the intent that the previous image 119 be replaced by the subsequent one.

Some data elements in the identification data 124 may be defined automatically by the system 100. For example, if the trigger is set to capture video clips of 15 seconds every 2 minutes, then to make the process more efficient the system 100 may automatically, without user interaction, record the time and date stamps which will uniquely identify these 15 second video clips. Alternatively, the system 100 may automatically generate an identification number as the next in a series and thereby uniquely identify the digital image 119.

In one embodiment, the user may define custom data elements which will define the identification data 124. Custom data elements may be defined when the system 100 is originally installed. Alternatively, the software of the system may allow a user to add and remove custom data elements as needed. Custom data elements may be a secondary identification number, a short name for the digital image 119, a non-standard unique identifier in use prior to installation of the system 100, and the like. The ability to allow for custom data elements allows the system 100 to remain very generic and still meet specific needs of a user. The ability to customize the identification data 124 provides great flexibility to the system 100.

Once the data structure 122 is created and holds the digital image 119 and its associated identification data 124, then the processing module 120 may make the data structure 122 available to a user interface 140. A user interface 140 may be a combination of hardware and software which enables a user to manage and use the data structure 122. The user interface 140 may permit use of either the digital image 119 or the identification data 124 or both. The user interface 140 may include a computer monitor, keyboard, mouse, printer, and hardware and software to operate them. Alternatively, the user interface 140 may be software such as a web browser operating on a general purpose computer connected to the system 100 by way of a computer network.

The user interface 140 allows a user to use the digital image 119 in a variety of ways. A user may display the digital image 119 on a computer or TV screen, print the digital image 119, broadcast the digital image 119 to others, store the digital image 119 on a remote computer and other like uses. If the digital images 119 are video clips 119, then the user may playback the video clips 119, edit the video clips 119 and other like uses.

Alternatively, the processing module 120 may store the data structure 122 in a database 150 prior to making the data structure 122 available to the user interface 140. The database 150 provides an efficient module for storing, manipulating, accessing and deleting data structures once they have been captured.

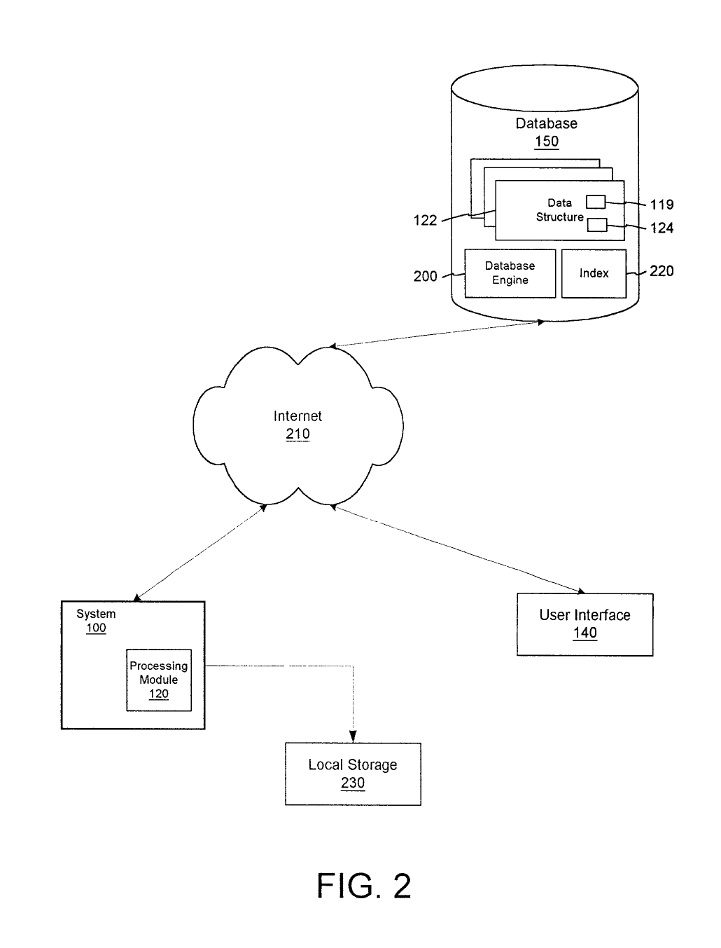

Referring specifically to FIG. 2, and generally to FIG. 1 a database 150 is illustrated in greater detail. A database 150 includes a database engine 200 and one or more data structures 122. The database engine 200 receives requests for data structures 122 from other modules such as processing modules 120 and services those requests. If a user interface 140 requests access to a data structure 122 from the processing module 120, then the processing module 120 makes a retrieve request of the database engine 200. The database engine 200 then searches the data structures 122 in the database 150. If the requested data structure 122 is found, then the database engine 200 sends a copy of the requested data structure 122 to the processing module 120 which then makes the data structure 122 available to the user interface 140. A similar exchange occurs when the processing module 120 makes an add, delete, or modify request for a particular data structure 122.

FIG. 2 illustrates how the system 100, the database 150, and the user interface 140 may operate at remote locations. In the depicted embodiment, the system 100, the database 150, and the user interface 140 may be connected to a computer network such as the Internet 210. The connections between the modules may be wireless, twisted pair, token ring, and the like. In one embodiment, all requests for data structures 122 from the user interface 140 may pass through the processing module 120. The request travels electronically from the user interface 140 through the Internet 210 to the processing module 120 of the system 100. From here, the processing module 120 handles the request as though the user interface 140 was locally located in relation to the system 100.

Alternatively, the system 100 may permit the user interface 140 to make requests directly of the database 150. Therefore, the user interface 140 may send a request for a data structure 122 through the Internet 210 to the database engine 200 of the database 150. Then, the database engine 200 may service the request in a similar manner to those which originated from the processing module 120.

One of ordinary skill in the art will recognize that logic to enable basic retrieval, display, and even manipulation of data structures 122 may easily be added to the controlling software defining the user interface 140. Additionally, functionality to retrieve, delete, add, and modify data structures 122 may be distributed or concentrated amongst the system 100, the database 150, and the user interface 140. These variations, and all others defined by the attached claims are to be considered within the scope of the present invention.

The Internet 210 is a well known world wide network of computers. Devices on the Internet 210 are connected such that any device connected to the Internet 210 may communicate with any other device connected to the Internet 210. The common communications protocols used on the Internet 210 allow various different computers and devices to exchange information.

The Internet 210 enables the use of digital images 119 across a broad geographic area. For example, the system 100 may be operating at a location such as the north pole. The trigger 130 may be set to fire, create trigger events 132, at one hour intervals. The video signal generator 112 may be a color video camera recording image data 114 of an iceberg about to break free from a glacier. The system 100 may be connected via satellite or ground based cables to the Internet 210. The database 150 may be in Washington D.C. The user interface 140 may be any world wide web browser connected to a website hosted on a web server in Los Angeles, Calif. The system 100 allows for the capture of the image data 114 in locations where users may not easily visit. The system 100 provides the convenience of access through user interfaces 140 such that traveling to the location is unnecessary.

In another example, the system 100 may be used in surgery in San Diego, Calif. An expert medical doctor may review the surgery or condition of organs of the patient from his desk in New York. The ability to provide access to the images on such a global scale saves a great deal of time and money. In addition, the user of the user interface 140 may return at a later time to review digital images 119 stored earlier in the database 150.

The ability to easily retrieve the digital images 119 using the system 100 and from remote locations are advantages which can not be under estimated. Conventional systems store images on film, micro-fiche, or computer CDs, disks, and tapes. Generally, these systems use manual filing and organizational techniques. Manual techniques are slow, and prone to human error.

The database 150 of the present invention provides for easy, quick access to data structures 122 and thereby digital images 119. To speed up the retrieval of the data structures 122 from the database 150, the system 100 indexes the data structures 122. An index 220 is a list of unique identifiers. The unique identifiers may be generated by the database 150 or come from the identification data 124. Each unique identifier in the index 220 is associated with a location in the database 150 of one data structure 122. An index 220 provides a structure in the database 150 which may be easily ordered and searched. Because the index 220 holds less data than an entire data structure 122, the search of the index 220 is faster than a search of the data structures 122 themselves. The index allows quicker retrieval of the data structure 122 than a standard electronic search of the database 150. Although, a standard machine search of the database 150 is still faster than most manual file searching techniques.

The database 150 provides the ability to allow access to the data structures 122 at different security levels. Some users may be allowed to add, delete, or modify different data structures 122. For security reasons, a single user may be allowed to perform any one of these operations, or any combination of them. Generally, access to the data structures 122 is controlled by use of a password to identify each user and their appropriate access level in relation to the data structures 122.

As illustrated in FIG. 2, the system 100 depends a great deal on the database 150. However, errors, technical problems, and physical interruptions can cause a database 150 to become disconnected from the Internet 210 or unavailable to the system 100. The database engine 200 may fail or a connection between the database 150 and the Internet 210 or the system 100 and the Internet 210 may become disconnected. In the embodiment depicted in FIG. 2, the invention is configured to accommodate for such problems by using local storage 230.

If a system 100 is configured with local storage 230, then the processing module 120 conducts a test prior to storing the data structure 122 in the database 150. If the processing module 120 detects that the database 150 is unavailable, then the processing module 120 stores the data structure 122 on local storage 230. Local storage 230 may include a diskette, a CD-ROM, a hard drive, a memory stick, and other like devices for storage local to the system 100. If the processing module 120 detects that the database 150 is available and that there is one or more data structures 122 stored on local storage 230, then the processing module 120 stores the most recently created data structure 122 in the database 150 and subsequently transfers the one or more data structure 122 stored on local storage 230 to the database 150. Otherwise, the processing module 120 stores the most recently created data structure 122 in the database 150 as previously described.

The ability to use local storage 230 if the database 150 is not available offers distinct advantages. The system 100 continues to function even though an error or problem has disconnected the system 100 from the database 150. This improves the reliability of the system 100. The system 100 may also be intentionally detached from the database 150, such as in a portable system 100. This allows the system 100 to provide more flexibility to the user.

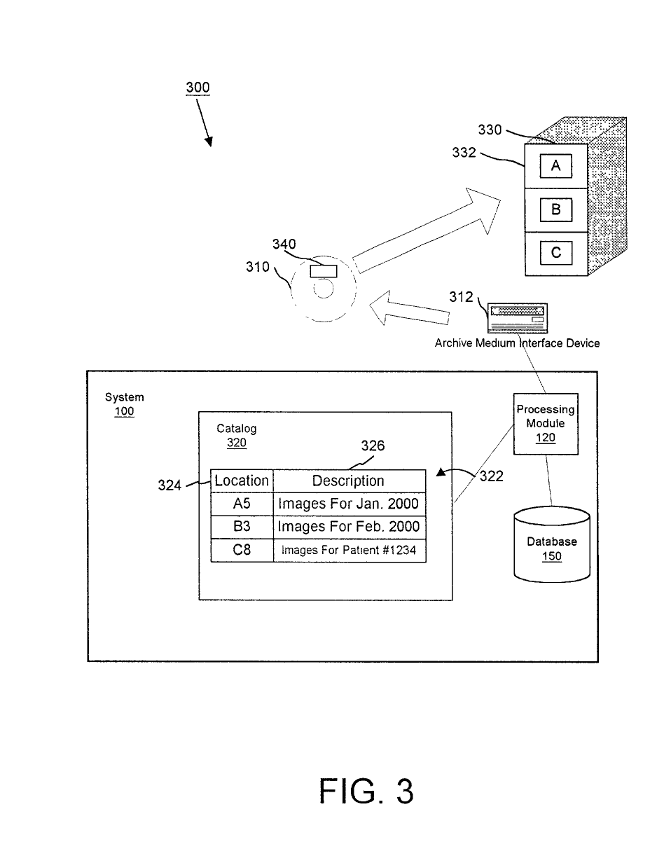

Referring now generally to FIGS. 1-2, and specifically to FIG. 3, in one embodiment, the system 100 provides an archive system 300. An archive system 300 is a system for storing digital images 119 which retain their value for a long time period but are not accessed often. The archive system 300 moves digital images 119 from one storage location, the database 150, to another, an archive medium 310. This frees space in the database 150 to accommodate more current digital images 119. The archive system 300 also provides a method for tracking where a group of digital images 119 are located within the archive system 300.

An archive system 300 includes archive medium 310, a catalog 320, and an archive 330. Archive medium 310 is a digital storage medium which is configured to store large number of data structures 122. Generally, archive medium 310 is a portable digital storage medium such as CD-ROMS, memory sticks, diskettes, digital tape cassettes, and the like. Alternatively, the archive medium 310 may be a set of dedicated hard drives or other non-portable digital storage medium.

Archive medium interface devices 312 are used by the system 100 to store data structures 122 on the archive medium 310 and to retrieve data structures 122 from the archive medium 310. Types of archive medium interface devices 312 may include CD-ROM drives, CD-R drives, tape drives, Floppy drives, memory stick reader/writers, and other similar devices which enable the system 100 to interface with the data on the archive medium 310.

Generally, archive medium 310 are capable of storing a number of data structures 122. Therefore, the archive medium 310 are configured with a label 340 for identifying the group of data structures 122 stored on each archive medium 310. For example, a label 340 on a digital medium 310 for a group of digital images 119 captured in January of 2000 may read “Images for January 2000”, or a label 340 for digital images 119 for a particular patient may read “Images for patient #1234.”

The processing module 120 transfers a group of data structures 122 from the database 150 to an archive medium 310. A user selects which data structures 122 are to be included on each archive medium 310 and defines the label 340 for the archive medium 310. The label 340 is then printed on paper which has an adhesive material on the side opposite the printed label 340. Alternatively, the user may write the label 340 on the archive medium 310 or another archive medium tag. Once the data structures 122 are selected, the system 100 transfers the data structures 122 from the database 150 to the archive medium 310. The system 100 also creates an entry 322 in the catalog 320.

The catalog 320 is a listing of the archive mediums 310 which have been created and stored in the archive 330. For each archive medium 310 containing the data structures 122, the catalog 320 has an entry 322. An entry 322 includes a location 324 and a description 326. The location 324 holds a text indicator of the location of the archive medium 310 in the archive 330. Generally, the description 326 is the same as the label 340 on the archive medium 310. Alternatively, the description 326 may be any text indicator describing the data structures 122 stored on the archive medium 310.

The archive 330 stores a plurality of archive mediums 310. Generally, the archive 330 is a physical storage location which is easily divided into locations 324 for archive mediums 310. In the depicted embodiment, the archive 330 is a filing cabinet with drawers 332 having labels corresponding to letters in the alphabet and locations within the drawers 332 having labels numbered sequentially for each drawer 332. Alternatively, the archive 330 may be a labeled room, with labeled shelves, and labeled locations on each shelf.

In the depicted embodiment, once a group of data structures 122 is stored on an archive medium 310, the user enters the location 324 and description 326 into the entry 322 of the catalog 320. The catalog 320 is stored in the database 150. Then, the label 340 is attached to the archive medium 310 and the archive medium 310 is stored at location 324 in the archive 330.

Retrieving a data structure 122 from the archive system 300 is a simple process. The user uses the system 100 to review the catalog 320. The catalog 320 tells the user what location 324 to go to for the archive medium 310. The user retrieves the archive medium 310 from the archive 330 and places it in the archive medium interface device 312. Using the archive medium interface device 312 and the processing module 120, the user selects the desired data structure 122 on the archive medium 310. Then, the processing module 120 transfers the desired data structure 122 back to the database 150. Once the desired data structure 122 is in the database 150, the user may use the desired data structure 122 just as with any other.

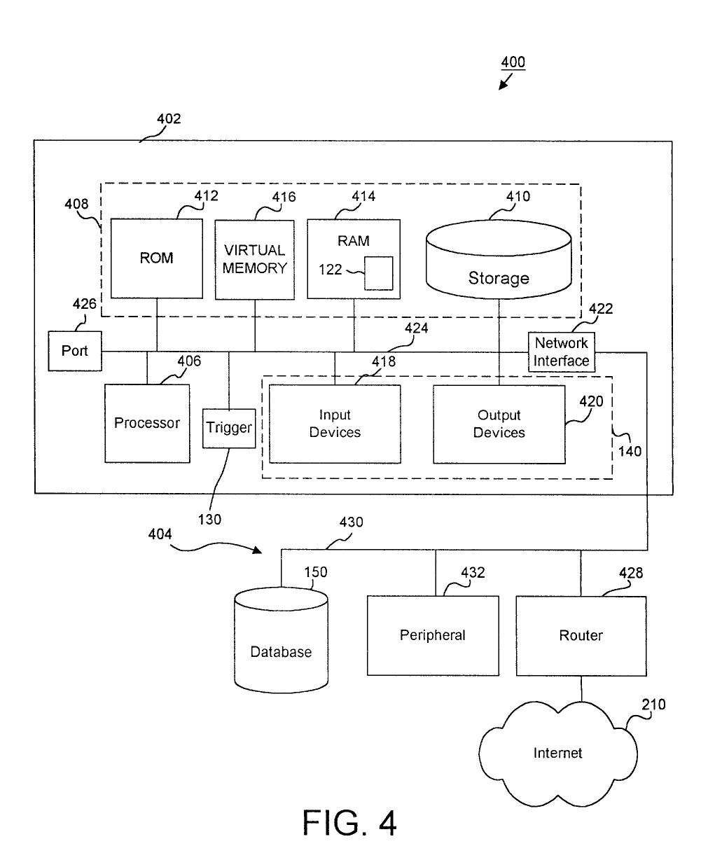

Referring now generally to FIGS. 1-3, and specifically to FIG. 4, a computer system 400 suitable for implementing one embodiment of the invention is illustrated. FIG. 4 is a block diagram which illustrates a computer system 400 in which executables, modules and applications, operating in accordance with the present invention, may be hosted on one or more computer stations 402 in a network 404. The network 404 may comprise a wide area network (WAN) and may also comprise an interconnected system of networks, one particular example of which is the Internet 210 and the World Wide Web supported on the Internet 210.

A typical computer station 402 may include a processor 406 and may be embodied as a central processing unit (CPU), logic device, a general purpose programmable device, application specific hardware, a state machine, or other processing machine. The processor 406 may be operably connected to one or more memory devices 408. The memory devices 408 are depicted as including a non-volatile storage device 410 such as a hard disk drive, CD-ROM drive, tape drive, or any other suitable storage device. The memory devices 408 further include a read-only memory (ROM) 412 and a random access volatile memory (RAM) 414. The RAM 414 may be used to store executable instructions by the processor 406 during execution. The RAM 414 may also be used to store one or more data structures 122 during execution. The memory devices 408 may further include a virtual memory 416 which, in one embodiment, is a portion of the non-volatile storage 410 which is used to extend the RAM 414.

The computer system 400 may also include an input device 418 for receiving inputs from a user or from another device. Similarly, an output device 420 may be provided within or be accessible from the computer system 400. A user interface 140 may be comprised of one or more input devices 418 and one or more output devices 420. For example, the user interface 140 may be comprised of a mouse, a keyboard, and a monitor. Together with software executing on the processor 406, these devices cooperate to receive commands from and present information to the user.

A network port such as a network interface card 422 may be provided for connecting to outside devices through the network 404. In the case where the network 404 is remote from the computer station, the network interface card 422 may comprise a modem, and may connect to the network 404 through a local access line such as a telephone line. Alternatively, the network interface card 422 may comprise a DSL, or other high speed internet connection hardware.

Internally, a system bus 424 may operably interconnect the processor 406, the memory devices 408, the input devices 418, the output devices 420, the trigger 130, the network card 422, and one or more additional ports 426. The system bus 424 may be thought of as a data carrier. As such, the system bus 424 may be embodied in numerous configurations. Wire, fiber optic line, wireless electromagnetic communications by visible light, infrared, and radio frequencies may likewise be implemented as appropriate for the system bus 424.

In general, the network 404 may comprise a single local area network, a wide area network, several adjoining networks, an intranet, or a system of interconnected networks such as the Internet 210. The individual stations 402 on the network 404 may have varying degrees and types of communication capabilities and logic capability. Different communication protocols, e.g., ISO/OSI, IPX, TCP/IP, may be used on the network, but in the case of the Internet 210, a single, layered communications protocol (TCP/IP) enables communications between the differing networks 404 and stations 402.

The network 404 may include a backbone 430 for interconnecting the stations 402. The backbone 430 may be embodied in any of the numerous configurations referred to with respect to the system bus 424. A router 428 may also connect to one or more other networks, including the Internet 210.

The stations 402 communicate with each other over the backbone 430 and/or over the Internet 210. The stations 402 may comprise a database 150, and/or peripherals 432 such as a printer, scanner, or facsimile machine. Thus, a communication link may exist, in general, between any of the stations 402 and the database 150.

The computer system 400 may also include a trigger 130 for manually or automatically creating a trigger event 132. The trigger 130 may be a button, switch, or other similar manual signaling device. Alternatively, the trigger 130 may be a sensor which detects rainfall, temperature, motion, light, and other like changes to an environment which the video signal generator 112 is focused on.

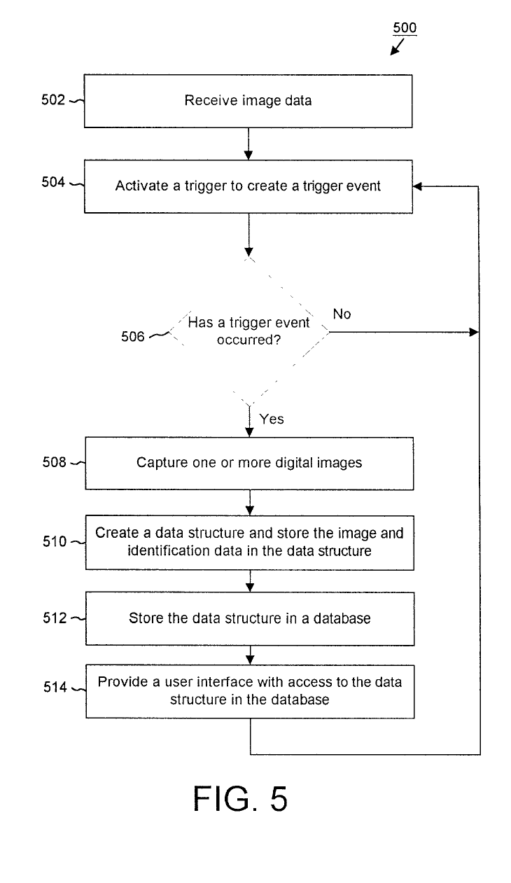

Referring generally to FIGS. 1 and 4 and specifically to FIG. 5, the present invention includes a sequence of method steps 500 for image capture, storage, and retrieval. The method begins in step 502 which includes various preparations necessary for practicing method 500. These preparations may include connecting a video signal generator 112 to the system 100, supplying power to the video signal generator 112 and system 100, and beginning execution of software in the system 100. Setup prior to step 502 may also include entering the identification data 124 which will be associated with the digital images 119. Setup may include indicating to the system 100 what type of trigger 130 to use and calibrating the trigger 130 to create a trigger event 132 under certain conditions.

In step 502, the input module 110 receives image data 114 from a video signal generator 112. A desired quantity of image data 114 is stored in a buffer 118 for capture by the system 100. In certain embodiments, the input module 110 may include a converter 116 to convert image data 114 from analog format into a digital format before storing the image data 114 in the buffer 118.

In step 504, a trigger 130 is activated to create a trigger event 132. A user has designated, in setup prior to step 502, what type of trigger 130 and what conditions activate the trigger 130. A trigger 130 may be a switch or a sensor.

Step 506 is a condition. The processing module 120 within the system 100 checks to determine if a trigger event 132 has occurred. If not, then the processing module 120 continues to wait for a trigger event 132. If a trigger event 132 has occurred, then the processing module 120 captures digital images 119 from the buffer 118.

In step 508, the processing module 120 recognizes a trigger event 132 and captures a digital image 119. The processing module 120 may capture a single digital image 119 or a series of digital images 119 to form a video clip. Capturing of a digital image 119 includes moving a copy of the digital image 119 from the buffer 118 to the processing module 120.

In step 510, the processing module 120 creates a data structure 122 for holding the digital images 119. The data structure 122 associates a digital image 119 or video clip with identification data 124. Identification data 124 uniquely identifies the digital images 119 in the data structure 122. Identification data 124 may include a plurality of data elements some of which may have been defined during setup prior to step 502. Other data elements of the identification data 124 may be defined by the system 100. These may include a time and date stamp. Step 510 further includes storing the digital image 119 and identification data 124 in the data structure 122.

In step 512, the data structure 122 is stored in a database 150. The data structure 122 may be a database record. Alternatively, the data structure 122 may be another structure which lends itself to storage in a database 150. The database 150 may be a SQL database 150 and may be physically located with the system 100. Alternatively, the database 150 may be located at a remote location accessible by the system 100 through a computer network such as the Internet 210. The data structure 122 may be indexed to provide more efficient access to the data structure 122.

In step 514, the processing module 120 allows a user interface 140 to access one or more data structures 122 stored in the database 150. The user interface 140 may be a combination of input devices 418, output devices 420, and software. The user interface 140 allows a user to access and use the digital images 119 in the database 150. The user interface 140 may be local to the other components of the system 100. Alternatively, the user interface 140 may be part of a station 402 connected to the system 100 by way of a computer network 404 such as the Internet 210.

Following step 514 the system 100 has completed one iteration of capturing digital images 119. The method continues with step 504. In step 504, the system 100 waits for the activation of the trigger 130 and creation of the trigger event 132.

In certain embodiments of the present invention, the system and method for image capture, storage, and retrieval, allows for capture of one or more images in a digital format and stores the images in a database to improve their accessability. These embodiments also store the images in a smaller physical space than conventional systems and may be used with a variety of image capture devices. Furthermore, these embodiments may also allow access to the images from remote locations by way of a computer network such as the Internet.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by Letters Patent is:

1. A method in a computer system for capturing and administering digital images, comprising:
(a) electronically receiving image data into an input module which is configured to buffer a desired quantity of image data at any given time;
(b) activating a trigger to create a trigger event;
(c) in response to the trigger event, a processing module electronically capturing a digital image from the image data received by the input module;
(d) in response to the trigger event, the processing module creating a data structure and storing the digital image in the data structure along with pre-defined identification data;
(e) storing the data structure in a database; and
(f) providing a user interface such that a user is allowed to use and access a data structure stored in the database.

2. A method as in claim 1, wherein the user interface comprises a web browser and further comprising a video signal generator generating the image data.

3. A method as in claim 2, wherein the web browser is configured to allow the user to access the digital image through a computer network.

4. A method as in claim 2, wherein the web browser is configured to allow the user to display, print, playback, and store the digital image on a remote computer.

5. A method as in claim 2, wherein the video signal generator is a video camera.

6. A method as in claim 5, wherein the image data transmitted from the video camera is in digital format.

7. A method as in claim 1, wherein the input module buffers the desired quantity of image data according to the last in, first out (LIFO) protocol.

8. A method as in claim 1, wherein the trigger is activated automatically based on the passage of time.

9. A method as in claim 1, wherein the trigger is activated manually by a user.

10. A method as in claim 1, further comprising:
storing the data structure in the database in response to the database being available; and
storing the data structure in local storage in response to the database being unavailable.

11. A method as in claim 1, further comprising:
initially storing the data structure in local storage in response to the database being unavailable; and
transferring at least one data structure from local storage to the database in response to the database becoming available.

12. A method as in claim 1, further comprising:
archiving the image data to an archive medium;
recording in a catalog the location of the archive medium and at least one identifier relating the archive medium to a location within an archive; and
offering the catalog for use by the user.

13. A method as in claim 1, further comprising:
indexing the data structure to facilitate retrieval of the image data at a later point in time.

14. A method as in claim 1, wherein use by the user comprises at least one of e-mailing, printing, faxing, copying, viewing, displaying, manipulating and broadcasting the image data.

15. A method as in claim 1, further comprising:
prior to step (b), a user defining the pre-defined identification data.

16. A method as in claim 1, wherein the digital image is compressed using a joint photographic experts group (JPEG) algorithm.

17. A method as in claim 1, wherein the processing module electronically captures a plurality of digital images to create a video clip.

18. A method as in claim 17, wherein the video clip is compressed using a motion picture experts group (MPEG) algorithm.

19. In a computer system, a method for capturing and administering digital images, the method comprising:
providing a medical video camera configured to record desired images of a medical procedure;
electronically receiving video data from the medical video camera into an input module which is configured to convert the video data into image data and buffer a desired quantity of image data at any given time;
activating a trigger to create a trigger event;
in response to the trigger event, a processing module electronically capturing a digital image from the image data received by the input module;
in response to the trigger event, the processing module creating a desired data structure and storing the digital image in the data structure along with pre-defined identification data;
storing the data structure in a database; and
providing a user interface such that a user is allowed to use and access a data structure stored in the database from a remote location.

20. A method as in claim 19, wherein the medical video camera is a camera selected from the group consisting of a computerized axial tomography (CAT scan) machine, an x-ray machine, a magnetic resonance imaging (MRI) machine, a patient bed monitoring camera, an arthroscope, a laparoscope, an ultrasound machine, and a general purpose camera.

21. A system for capturing and administering digital images, comprising:
an input device configured to electronically receive and buffer image data such that a desired quantity of image data is available at any given time;
a storage device configured to maintain a database and a plurality of data structures;
a trigger configured to create a trigger event signal;
a user interface configured to receive user commands and present data for use by a user; and
a processor connected to the digital input receiver, storage device, trigger, and output device and programmed to,
electronically capture a digital image from the input device in response to the trigger event signal,
create a data structure and store the digital image and pre-defined identification data in the data structure,
store the data structure in the database within the storage device, and
provide access to the database by way of a user interface such that a user is allowed to use a data structure stored in the database.

22. A system for capturing and administering digital images, comprising:
means for electronically receiving image data into an input module which is configured to buffer a desired quantity of image data at any given time;
means for creating a trigger event;
means for responding to the trigger event and electronically capturing a digital image from the image data received by the input module;
means for responding to the trigger event and creating a desired data structure and storing the digital image in the data structure along with pre-defined identification data;
means for storing the data structure in a database which is electronically connected to the system;
means for providing access to the database such that a user is allowed to use a data structure stored in the database.

23. A system as in claim 22, further comprising:
an image data generating means configured to transmit image data to the means for electronically receiving image data into an input module.

24. A system as in claim 23, wherein the data structure comprises a database record.

25. A computer readable medium having stored thereon computer executable instructions for performing a method for capturing and administering digital images, the method comprising:
electronically receiving image data into an input module which is configured to buffer a desired quantity of image data at any given time;
activating a trigger to create a trigger event;
in response to the trigger event, a processing module electronically capturing a digital image from the image data being received by the input module;
further in response to the trigger event, a processing module creating a desired data structure and storing the digital image in the data structure along with pre-defined identification data;
storing the data structure in a database; and
providing a user interface such that a user may use a data structure stored in the database.

26. The computer readable medium of claim 25, wherein the user interface comprises a web browser configured to allow the user to access the digital image through a computer network and further comprising a video signal generator generating the image data.

27. The computer readable medium of claim 26, wherein the video signal generator is a video camera.

28. The computer readable medium of claim 25, wherein the trigger is activated automatically based on the passage of time.

29. The computer readable medium of claim 25, wherein the trigger is activated manually by a user.

30. The computer readable medium of claim 25, further comprising:
storing the data structure in the database in response to the database being available; and
storing the data structure in local storage in response to the database being unavailable.

31. The computer readable medium of claim 25, further comprising:
initially storing the data structure in local storage in response to the database being unavailable; and
transferring at least one data structure from local storage to the database in response to the database becoming available.

32. The computer readable medium of claim 25, further comprising:
archiving the image data to an archive medium;
recording in a catalog the location of the archive medium and at least one identifier relating the archive medium to a location within an archive; and
offering the catalog for use by the user.
